(19) United States
(12) Patent Application Publication
(10) Pub. No.: US 2024/0409105 A1
(43) Pub. Date: Dec. 12, 2024

(54) STRESS MITIGATION WHEN PERFORMING SUGGESTED MANEUVERS

(71) Applicant: TOYOTA MOTOR ENGINEERING & MANUFACTURING NORTH AMERICA, INC., PLANO, TX (US)

(72) Inventors: SEYHAN UCAR, Mountain View, CA (US); TAKAMASA HIGUCHI, Mountain View, CA (US); ONUR ALTINTAS, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, Toyota-Shi (JP)

(21) Appl. No.: 18/331,089

(22) Filed: Jun. 7, 2023

(51) Int. Cl. B60W 50/00; B60W 60/00; G08G 1/0967

(52) U.S. Cl. CPC B60W 50/0098; B60W 60/0013; G08G 1/096725; G08G 1/096775; G08G 1/096791; B60W 2540/22; B60W 2554/4042; B60W 2554/4044; B60W 2556/45; B60W 2556/65; G08G 1/096783

(57) ABSTRACT

Systems and methods are provided for mitigating stress experienced by a driver or passenger of a vehicle due to motive guidance received by the vehicle. For example, a vehicle may be instructed/may receive driving guidance to take a particular action(s) or perform a maneuver(s). One or more elements in the environment about or relative to the vehicle may cause the driver/passenger stress. A stress mitigation system may determine a cause of the stress, and seek to mitigate that stress by generating a micro cloud of environmental elements (e.g., neighboring vehicles, roadside equipment, etc.) and reorganizing one or more of those environmental elements.

### TECHNICAL FIELD

The present disclosure relates generally to driver assistance systems, and in particular, some implementations may relate to mitigating or reducing stress associated with driving in accordance with guidance from driver assistance systems by the creation of a micro cloud that can be instructed to perform an action(s)/engage in a driving maneuver(s) that will relieve the stress typically experienced by the driver of an ego vehicle.

### DESCRIPTION OF RELATED ART

Advanced Driver Assistance Systems (ADAS) can refer to electronic systems that assist a vehicle operator/driver while driving, parking, or otherwise maneuvering a vehicle. That is, ADAS may be considered a type or embodiment of semi-autonomous driving systems. ADAS can increase vehicle and road safety by minimizing human error, and introducing some level of automated vehicle/vehicle feature control. Autonomous/automated driving systems (“ADS”) may go further than ADAS by leaving responsibility of maneuvering and controlling a vehicle to the autonomous driving systems. For example, an autonomous driving system may comprise some package or combination of sensors to perceive a vehicle's surroundings, and advanced control systems that interpret the sensory information to identify appropriate navigation paths, obstacles, road signage, etc.

### BRIEF SUMMARY OF THE DISCLOSURE

In accordance with one embodiment, a method comprises identifying, at a stress mitigation server, existence of stress to a passenger of a vehicle upon receipt of vehicle guidance by the vehicle. The method further comprises inferring, by the stress mitigation server, a cause of the stress due to the received guidance, generating, by the stress mitigation server, a micro cloud relative to the vehicle, and reorganizing, by the stress mitigation server, the micro cloud to mitigate the stress.

In some embodiments, the vehicle guidance comprises advanced driving assistance system (ADAS) or autonomous driving system (ADS) guidance.

In some embodiments, identifying the existence of stress comprises receiving driving conditions characterizing a current driving environment at a digital twin system.

In some embodiments, the method further comprises performing one or more simulations using a digital twin representative of the passenger at the digital twin system based on the received driving conditions.

In some embodiments, the receipt of the vehicle guidance occurs at a local stress mitigation circuit of the vehicle.

In some embodiments, the local stress mitigation circuit of the vehicle is operatively connected to the stress mitigation server, the stress mitigation server comprising a remote stress mitigation circuit corresponding to the local stress mitigation circuit of the vehicle.

In some embodiments, the inferring of the cause of the stress comprises identifying one or more aspects or results of the received guidance leading to the existence of the stress.

In some embodiments, generating the micro cloud comprises identifying at least one or more elements of an environment relative to the vehicle or one or more geographical areas relative to the vehicle that is the cause of the stress or can be reorganized to mitigate the stress.

In some embodiments, the micro cloud comprises at least one of one or more vehicles neighboring the vehicle, one or more vehicles to-be-neighboring the vehicle, or one or more roadside equipment.

In some embodiments, the reorganization of the micro cloud comprises altering at least one of a current operating speed or current direction of travel of the one or more vehicles neighboring the vehicle, or one or more vehicles to-be-neighboring the vehicle.

In some embodiments, the altering of the at least one the current operating speed or current direction of travel of the one or more vehicles neighboring the vehicle, or one or more vehicles to-be-neighboring the vehicle, comprises transmitting, by the stress mitigation server, guidance, to a respective local stress mitigation circuit of the one or more vehicles neighboring the vehicle, or the one or more vehicles to-be-neighboring the vehicle.

In some embodiments, the reorganization of the micro cloud comprises altering a current operating condition of the one or more roadside equipment.

In some embodiments, the altering of the current operating condition of the roadside equipment, comprises transmitting, by the stress mitigation server, guidance, to a respective local stress mitigation circuit of the one or more roadside equipment.

In accordance with an embodiment, a system, comprises one or more local stress mitigation circuits, and a stress mitigation server operating to: receive driving conditions characterizing a current driving environment relative to an ego vehicle upon the ego vehicle receiving driving guidance; identify existence of stress to a passenger of the vehicle based on known passenger characteristics and learned impact of the received driving conditions relative to the known passenger characteristics; infer a cause of the stress due to the received driving guidance; generate a micro cloud relative to the ego vehicle; and transmit, to the one or more local stress mitigation circuits, instructions reorganizing the micro cloud to mitigate the stress.

In some embodiments, the one or more local stress mitigation circuits is implemented in at least one of one or more vehicles neighboring the vehicle, one or more vehicles to-be-neighboring the vehicle, or one or more roadside equipment.

In some embodiments, the at least one of the one or more vehicles neighboring the vehicle, the one or more vehicles to-be-neighboring the vehicle, or the one or more roadside equipment are members of the micro cloud.

In some embodiments, the stress mitigation server generates the micro cloud by identifying at least one or more elements of the current driving environment or a future driving environment relative to the vehicle, or one or more geographical areas relative to the vehicle that is the cause of the stress or can be reorganized to mitigate the stress.

In some embodiments, the instructions reorganizing the micro cloud comprises instructions to alter at least one of a current operating speed or current direction of travel of the one or more vehicles neighboring the vehicle, or one or more vehicles to-be-neighboring the vehicle.

In some embodiments, the instructions reorganizing the micro cloud comprises instructions to alter a current operating condition of the one or more roadside equipment.

In some embodiments, the stress mitigation server identifies the existence of stress by performing one or more simulations using a digital twin representative of the passenger of the vehicle at a digital twin system implemented as part of the stress mitigation server based on the received driving conditions.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for mitigating stress due to ADAS guidance in accordance with one embodiment of the systems and methods described herein.

FIG. 3 is an example network architecture of a stress mitigation system in accordance with various embodiments disclosed herein.

FIGS. 4A, 4B, and 4C illustrates an example progression of a stressful scenario and mitigation of the stress therefrom in accordance with various embodiments disclosed herein.

FIG. 5 is a flow chart illustrating example operations for mitigating stress in accordance with various embodiments disclosed herein.

FIG. 6 is an example computing component that may be used to implement various features of embodiments described in the present disclosure.

The figures are not exhaustive and do not limit the present disclosure to the precise form disclosed.

### DETAILED DESCRIPTION

Human drivers or vehicle operators remain a part of vehicle operation. As noted above, ADAS can increase vehicle and road safety by minimizing human error, and introducing some level of automated vehicle/vehicle feature control. However, ADAS can also cause drivers stress or can cause drivers to experience some form of negative driving experience (although embodiments are described in the context of stress, embodiments can be used to infer/mitigate any sort of negative driving experience). That is, when ADAS generates a command or control instruction prompting or suggesting some action(s) or maneuver(s) to be taken by a vehicle driver or operator, that vehicle driver/operator may experience stress as a result of having to take such an action(s) or effectuate such a maneuver(s). The surrounding area or traffic about the vehicle can further exacerbate the stress that the driver may experience or feel.

One example of ADAS is lane change assistance, where based on factors such as traffic density around a vehicle, or perceived obstacles in or near the vehicle's area of operation or in a surrounding/neighboring area, a vehicle may be provided some guidance to deal with such factors. For example, a vehicle's ADAS may perceive one or more obstacles in the vehicle's current path of travel. If the vehicle's ADAS determines that the perceived one or more obstacles presents some safety hazard, the ADAS may generate guidance that the driver is expected to follow. In the example situation, the ADAS may generate guidance in the form of, e.g., an audio/visual/physical prompt, such as beeping in conjunction with a warning icon or blinking light or vibrating vehicle component (steering wheel or seat). The generated guidance may suggest to the driver that he/she should change lanes to avoid the perceived one or more obstacles. However, if the driver were to comply with the guidance from the ADAS, the driver would have to maneuver the vehicle next to a semi-truck. This particular driver may experience stress or other negative/undesirable emotion or feeling when forced to drive next to a semi-truck. Other types of guidance can cause stress or feelings of nervousness, worry, anxiety, etc., such as sudden lane changes, sudden acceleration or sudden/severe braking, to name few.

Accordingly embodiments of the technology described herein are directed to a driver stress mitigation system that can reduce or mitigate the stress that a vehicle operator experiences when complying with ADAS guidance or when receiving ADAS guidance. It should be understood that a vehicle operator can experience stress when actually performing a suggested action(s) or maneuver(s), after the completion of such suggested action(s) or maneuver(s), or even prior to performing the suggested action(s) or maneuver(s), e.g., upon receipt of, but before performing the suggested action(s) or maneuver(s). It should be noted that contemplated embodiments are not limited to ADAS guidance. That is, embodiments are capable of reducing stress for a passenger of a fully-autonomous vehicle if/when the fully autonomous vehicle engages in actions or maneuvers that may cause the passenger stress. Thus, it would be understood by those of ordinary skill that the described embodiments can be adapted to passengers rather than drivers and any vehicle capable of taking action/maneuvering in a manner that generates stress or a negative driving/riding experience.

Different vehicle operators may experience stress in different ways and due to different triggers. In order to determine what may cause unwanted stress or an undesirable driving experience, a driver model or profile may be leveraged. In some embodiments, a driver model may be generated by a digital twin system (or some other data analytics or artificial intelligence (AI) or machine-learning (ML) system) based, e.g., on, at least, driving data associated with the vehicle operator (real-time or historical as may be appropriate for a given driving scenario). Such a driver model can be used to predict, based on, e.g., real-time data regarding a current driving scenario, that guidance from the ADAS may cause stress. For example, over time, the digital twin system may learn that certain maneuvers cause a particular vehicle operator stress, such as the aforementioned travel near or next to a semi-truck. Accordingly, when a driving scenario involves guidance that may place the vehicle next to a semi-truck, the digital twin system can output a prediction that such guidance may cause stress to the operator of the vehicle.

Upon a determination that the ADAS of the vehicle has generated potentially stress-inducing guidance, the driver stress mitigation system may form a micro (or nano) cloud about or near the vehicle. It should be understood that the terms micro/nano as used herein are not necessarily meant to suggest a particular number of vehicles, but rather a general reference applicable to some subset of vehicles neighboring or proximate to, e.g., an ego vehicle. The driver stress mitigation system may then instruct the vehicles making up the micro cloud vis-à-vis ADAS guidance or other instruction mechanism to perform a certain action(s) or maneuver(s) that will assist in/result in mitigation the stress experienced by the operator of the vehicle at issue, also referred to as an ego vehicle.

For example, upon the ADAS of an ego vehicle generating some guidance that is expected to be followed by the operator of the ego vehicle, the driver stress mitigation system, based on the driver model/digital twin system, analyzes the guidance, and determines whether or not such guidance can cause the vehicle operator stress. Following the above example, when the guidance will result in the ego vehicle driving next to a semi-truck, the digital twin system can output a determination or inference that the given guidance will cause stress. The driver stress mitigation system can then determine an appropriate micro cloud formed of one or more other vehicles in the vicinity of/surrounding the ego vehicle, referred to as vehicular micro cloud members. The vehicular micro cloud members in the micro cloud may then receive instructions or guidance from the driver mitigation system vis-à-vis their own respective ADAS to change lanes, drive faster or slower, turn off a path, and so on to, in this case, create space for the ego vehicle to change lanes, so that when the ego vehicle changes lanes (in accordance with the guidance) it will no longer result in the vehicle being next to a semi-truck. For example, a neighboring vehicular micro cloud member making up the micro cloud may currently be traveling in the lane to which the ego vehicle has been instructed to change. Accordingly, the neighboring vehicular micro cloud member may receive guidance to speed up so that when the ego vehicle completes its lane change, it has the requisite space/room so that it can speed up and pass the semi-truck. In this way, the stress that the operator/passenger of the ego vehicle may have experienced is mitigated as a result of being able to move away from the semi-truck. Without the benefit of the driver stress mitigation system, the neighboring vehicular micro cloud member may have remained at its current speed, thereby blocking movement of the ego vehicle away from the semi-truck, in effect, pinning the ego vehicle next to the semi-truck. It should be understood that the semi-truck itself, i.e., a cause or a part of the cause of the stress to the driver, may be a vehicular micro cloud member that ultimately, can mitigate the stress via reorganization.

To the above, it should be noted that conventional ADAS guidance is typically generated by assessing/analyzing current information or data about an ego vehicle and state of the vehicle's operator. Typically, guidance is prioritized according to risk. However, the state of the ego vehicle's surroundings/environment as well as the stress that may be caused to the ego vehicle's operator by the surroundings/environment are ignored. For example, conventional ADAS can include predictive analytics, where a driver's stress level is predicted according to some specific driving events and guidance can be generated. However, without considering the surrounding environment, e.g., other vehicles, roadway infrastructure, obstacles, traffic, and so on, while a particular driving action or maneuver may not cause stress to the vehicle operator, the vehicle operator, as a result of following guidance may end up in another stress-inducing scenario. And even if conventional ADAS were able to recognize and provide further guidance, the driver nevertheless experiences stress, and possibly repeatedly as he/she, pursuant to following the ADAS guidance goes from one stressful scenario to another stressful scenario, and so on. In other words, while conventional ADAS may be able to detect a stressed driver, its guidance is merely reactionary to scenarios that have already caused the driver stress.

As used herein, the words “geographic location,” “location,” “geographic position” and “position” refer to a latitude and longitude of an object (or, a latitude, longitude, and elevation of an object), such as a vehicle, a roadside equipment/unit, etc. As used herein, the words “geographic area”, “area,” and “region” refer to a physical space surrounding a geographic location and/or object (e.g., an area of defined space surrounding a geographic location or position). In the case of a traveling object (e.g., a vehicle) the geographic area or region can travel with the object.

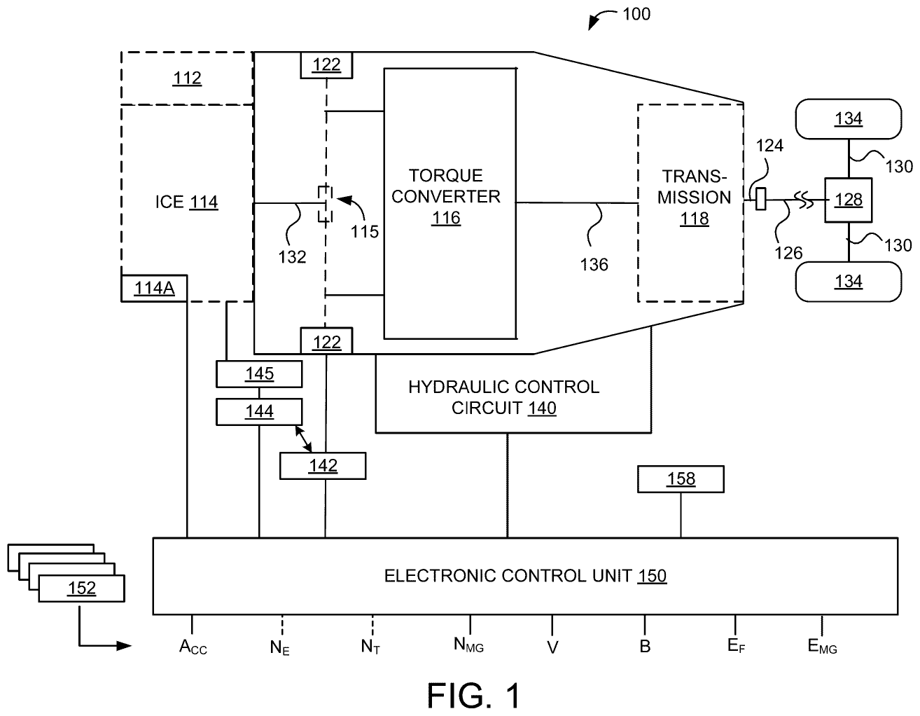

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for remote micro cloud formation can be implemented in other types of vehicles including gasoline- or diesel-powered vehicles, fuel-cell vehicles, electric vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 114 (engine RPM), a rotational speed, NMG, of the motor 122 (motor rotational speed), and vehicle speed, NV. These may also include torque converter 116 output, NT (e.g., output amps indicative of motor output), brake operation amount/pressure, B, battery SOC (i.e., the charged amount for battery 144 detected by an SOC sensor). Accordingly, vehicle 100 can include a plurality of sensors 152 that can be used to detect various conditions internal or external to the vehicle and provide sensed conditions to engine control unit 150 (which, again, may be implemented as one or a plurality of individual control circuits). In one embodiment, sensors 152 may be included to detect one or more conditions directly or indirectly such as, for example, fuel efficiency, EF, motor efficiency, EMG, hybrid (internal combustion engine 114+MG 112) efficiency, acceleration, ACC, etc.

In some embodiments, one or more of the sensors 152 may include their own processing capability to compute the results for additional information that can be provided to electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

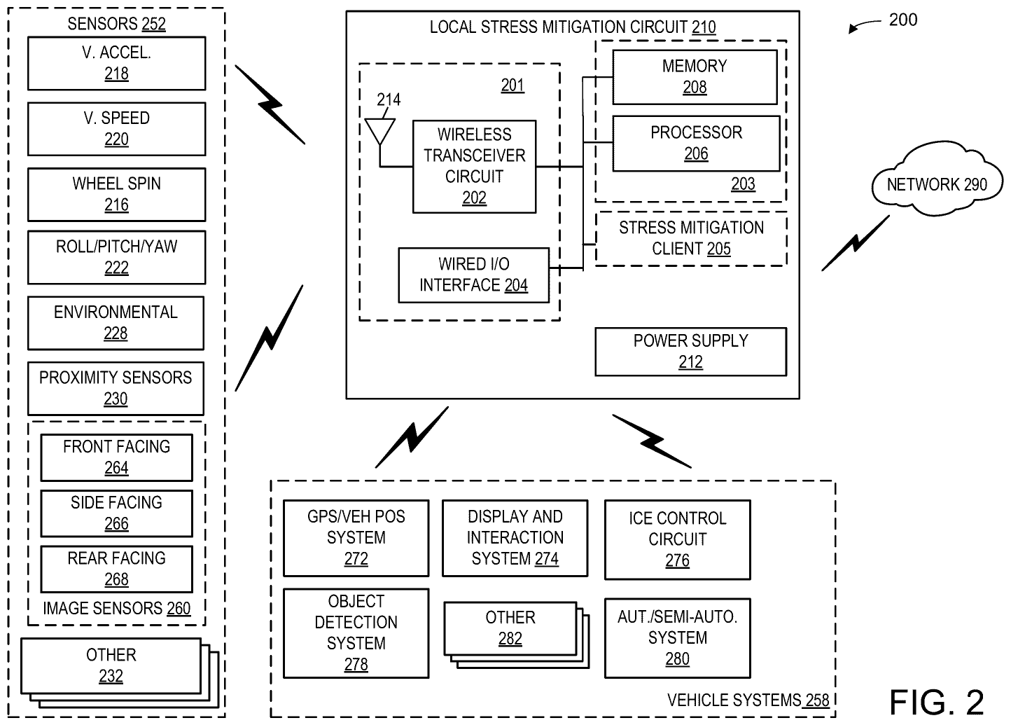

FIG. 2 illustrates an example architecture for mitigating driver stress in accordance with one embodiment of the systems and methods described herein. Referring now to FIG. 2, in this example, stress mitigation system 200 includes a local stress mitigation circuit 210, a plurality of sensors 252 and a plurality of vehicle systems 258. Sensors 252 (such as sensors 152 described in connection with FIG. 1) and vehicle systems 258 (such as systems 158 described in connection with FIG. 1) can communicate with local stress mitigation circuit 210 via a wired or wireless communication interface. Although sensors 252 and vehicle systems 258 are depicted as communicating with local stress mitigation circuit 210, they can also communicate with each other as well as with other vehicle systems. Local stress mitigation circuit 210 can be implemented as an ECU or as part of an ECU such as, for example electronic control unit 150. In other embodiments, local stress mitigation circuit 210 can be implemented independently of the ECU.

Local stress mitigation circuit 210 in this example includes a communication circuit 201, a decision circuit 203 (including a processor 206 and memory 208 in this example) and a power supply 212. Components of local stress mitigation circuit 210 are illustrated as communicating with each other via a data bus, although other communication in interfaces can be included. Local stress mitigation circuit 210 in this example also includes a local stress mitigation client 205 that can be operated to receive ADAS guidance from a stress mitigation server (to be discussed below), which can then be relayed to autonomous or semi-autonomous driving system 280. Local stress mitigation client 205 may also be operated to transmit to the aforementioned stress mitigation server, relevant data regarding a current driving scenario being experienced by an ego vehicle. Such current driving scenario data can be used in conjunction with a driver model or profile to determine whether current conditions may result in the driver of the ego vehicle stress upon receiving/performing/complying with ADAS guidance. For example, and as will also be described in greater detail below, the aforementioned stress mitigation server may include, at least in part, a digital twin system that can receive as input, current driving conditions reflecting or characterizing a current driving scenario/environment, e.g., the ego vehicle's position/location relative to surrounding traffic, roadway infrastructure, lane, etc. The digital twin system may then perform simulations to determine or infer what, based on the current driving conditions/environment, may cause the driver of the ego vehicle to experience stress. In some embodiments, local stress mitigation client 205 may be used to transmit a driver profile associated with the driver of an ego vehicle to the stress mitigation server.

It should be understood that one or more thresholds or weights may be associated with levels of stress, and thus, ADAS guidance for the micro cloud alluded to above, can be generated accordingly. For example, if a particular ADAS guidance may be inferred to cause the driver of an ego vehicle a minimal amount of stress, the micro cloud may be instructed to perform minimal actions/maneuvering to mitigate the driver's stress. On the other hand, if a particular ADAS guidance is inferred to cause a high level of stress, the vehicular cloud may be instructed, vis-a-visa ADAS guidance, to perform more extreme or severe stress mitigation actions/maneuvers (e.g., providing a wider berth for the ego vehicle to pass or clear some obstacle, neighboring vehicle, etc.).

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as, one or more of the following elements: position data; vehicle speed data; risk mitigation data; and stress data, as described below, along with other data as needed. Memory 208 can be made up of one or more modules of one or more different types of memory, and may be configured to store data and other information as well as operational instructions that may be used by the processor 206 to local stress mitigation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a local stress mitigation circuit 210.

Communication circuit 201 includes either or both a wireless transceiver circuit 202 with an associated antenna 214 and a wired I/O interface 204 with an associated hardwired data port (not illustrated). Communication circuit 201 can provide for V2X and/or V2V communications capabilities, allowing local stress mitigation circuit 210 to communicate with edge devices, such as roadside unit/equipment (RSU/RSE), network cloud servers and cloud-based databases, and/or other vehicles via network 290. For example, V2X communication capabilities allows local stress mitigation circuit 210 to communicate with edge/cloud devices, roadside infrastructure (e.g., such as roadside equipment/roadside unit, which may be a vehicle-to-infrastructure (V2I)-enabled street light or cameras, for example), etc. Local stress mitigation circuit 210 may also communicate with other connected vehicles over vehicle-to-vehicle (V2V) communications. For example, current driving conditions/environment data may include data relayed to the ego vehicle from, e.g., an RSE (instead of from an on-board sensor, such as sensors 252), which can then be relayed to the stress mitigation server.

As used herein, “connected vehicle” refers to a vehicle that is actively connected to edge devices, other vehicles, and/or a cloud server via a network through V2X, V2I, and/or V2V communications. An “unconnected vehicle” refers to a vehicle that is not actively connected. That is, for example, an unconnected vehicle may include communication circuitry capable of wireless communication (e.g., V2X, V2I, V2V, etc.), but for whatever reason is not actively connected to other vehicles and/or communication devices. For example, the capabilities may be disabled, unresponsive due to low signal quality, etc. Further, an unconnected vehicle, in some embodiments, may be incapable of such communication, for example, in a case where the vehicle does not have the hardware/software providing such capabilities installed therein.

As this example illustrates, communications with local stress mitigation circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by local stress mitigation circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or may not otherwise be included on a standard vehicle with which the stress mitigation system 200 is implemented. In the illustrated example, sensors 252 include vehicle acceleration sensors 218, vehicle speed sensors 220, wheelspin sensors 216 (e.g., one for each wheel), accelerometers such as a 2-axis accelerometer 222 to detect roll, pitch and yaw of the vehicle, environmental sensors 228 (e.g., to detect salinity or other environmental conditions), and proximity sensor 230 (e.g., sonar, radar, lidar or other vehicle proximity sensors). Additional sensors 232 can also be included as may be appropriate for a given implementation of stress mitigation system 200.

System 200 may be equipped with one or more image sensors 260. These may include front facing image sensors 264, side facing image sensors 266, and/or rear facing image sensors 268. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 260 can be used to, for example, to detect objects in an environment surrounding a vehicle comprising stress mitigation system 200, for example, surrounding vehicles, roadway environment, road lanes, road curvature, obstacles, and so on. For example, one or more image sensors 260 may capture images of vehicles present in the surrounding environment. As another example, object detecting and recognition techniques may be used to detect objects and environmental conditions, such as, but not limited to, road conditions, surrounding vehicle behavior (e.g., driving behavior and the like), and so on. Additionally, sensors may estimate proximity between vehicles. For instance, the image sensors 260 may include cameras that may be used with and/or integrated with other proximity sensors 230 such as LIDAR sensors or any other sensors capable of capturing a distance. As used herein, a sensor set of a vehicle may refer to sensors 252.

Vehicle systems 258, for example, systems and subsystems 258 described above with reference to the example of FIG. 2, can include any of a number of different vehicle components or subsystems used to control or monitor various aspects of the vehicle and its performance. In this example, the vehicle systems 258 includes a vehicle positioning system 272; engine control circuits 276 to control the operation of engine (e.g. Internal combustion engine 124 and/or motors 122); object detection system 278 to perform image processing such as object recognition and detection on images from image sensors 260, proximity estimation, for example, from image sensors 260 and/or proximity sensors, etc. for use in other vehicle systems; vehicle display and interaction system 274 (e.g., vehicle audio system for broadcasting notifications over one or more vehicle speakers), vehicle display system and/or the vehicle dashboard system), and other vehicle systems 282 (e.g., ADAS, autonomous or semi-autonomous driving systems 280, such as forward/rear collision detection and warning systems, pedestrian detection systems, autonomous or semi-autonomous driving systems, and the like).

As alluded to above, embodiments of the disclosed technology mitigate stress that an ego vehicle operator may feel or experience pursuant to guidance, such as ADAS/ADS/other guidance that puts/will put the ego vehicle operator in a situation/scenario/conditions that cause the ego vehicle operator to experience stress. Autonomous/semi-autonomous driving systems 282 may accordingly generate such guidance, e.g., based on information or data gleaned from sensors 252, vehicle positioning system 272, etc. Upon receiving such guidance, the information or data, along with the guidance itself (or information regarding the guidance) can be sent via local stress mitigation client 205 to a stress mitigation server. The stress mitigation server can infer whether or not the guidance, given the current conditions (e.g., sensor/vehicle positioning system-based information, in this example) as well as other information/data from other relevant sources if they exist, e.g., neighboring RSEs (or similar information/data from neighboring vehicles) relative to a profile or digital twin model of the ego vehicle operator, may cause stress to the ego vehicle operator. If a determination is made that the guidance will or may cause stress (one or more thresholds may be considered to determine if the induced stress rises to level of warranting action), a micro cloud can be formed. The micro cloud may comprise one or more neighboring vehicles in some geographical area about the ego vehicle that the stress mitigation server determines can be used to alleviate the stress to the ego vehicle operator. The formation of such a micro cloud can vary based on current conditions, e.g., whether the ego vehicle is at an intersection, the speed of travel of the ego vehicle, the speed of travel of surrounding traffic, and so on. Ultimately, the stress mitigation server provides guidance to the one or more vehicles comprising the micro cloud. This guidance (which may be received by such vehicles' own, respective stress mitigation clients), when followed, results in reorganizing the micro cloud in such a way that the ego vehicle will no longer be put into a position/in conditions that causes stress to the ego vehicle operator. For example, the one or more vehicles comprising the micro cloud can be instructed or guided to adjust their respective speeds of travel, change lanes, etc. to, e.g., alleviate or remove the conditions that would cause stress to the ego vehicle operator.

The vehicle positioning system 272 can include a global positioning system (GPS). Vehicle positioning system 272 can be used, at least in part, to determine/assist in determining a relevant geographical area comprising or encompassing/including one or more vehicles proximate to the ego vehicle that can be guided to mitigate stress for the ego vehicle. For example, upon receiving ADAS guidance, vehicle positioning system 272 may determine the ego vehicle's position/location relative to surrounding traffic or other environmental elements. This information, along with the ADAS guidance can be sent to the stress mitigation server (as alluded to above), so that the stress mitigation server can determine whether the ADAS guidance will potentially induce stress to the ego vehicle driver, and what vehicles should be included in a micro cloud that can be guided to mitigate the stress that the ego vehicle driver may experience. For example, the relevant geographical area may be determined to be a geographical area including those lanes immediately to the left/right of an ego vehicle's current lane of travel and those lanes immediately to the left/right of the ego vehicle's lane of travel after complying with the ADAS guidance, and any section(s) of roadway therebetween. Vehicles that fall into that geographical area can be those vehicles making up a micro cloud.

Local stress mitigation circuit 210 may be installed on a DSRC-equipped vehicle. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an ADAS of a modern vehicle require positioning information that describes the location of the vehicle with lane-level accuracy. In addition, the current standard for DSRC requires that the location of the vehicle be described with lane-level accuracy.

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 290 may include one or more IEEE 802.11 wireless networks.

In some embodiments, the network 290 includes a V2X network (e.g., a V2X wireless network). It should be noted that in some embodiments, those vehicles (or RSEs) that are in communication range (or that can communicate within a V2X network) with the ego vehicle can be a factor in determining a micro cloud. The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term (LTE); Evolution millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

According to some embodiments, in the case of an ego vehicle, local stress mitigation client 205 includes code and routines that are operable, when executed by processor 206, to cause the processor 206 to collect data captured by captured from sensors 252 and/or vehicle system 258 (e.g., sensor data) and relay that collected data to the stress mitigation server to be processed. The driving or driving conditions data can be communicated to the stress mitigation server, which can be embodied by or as an edge/cloud server, via communication circuit 201. In the case of a vehicle that is part of a micro cloud, local stress mitigation client 205 may include further code and routines that are operable, when executed by processor 206, to cause processor 206 to receive via, e.g., communication circuit 201, stress mitigation ADAS guidance, that can ultimately be received by and effectuated by that vehicle's respective autonomous/semi-autonomous system 280.

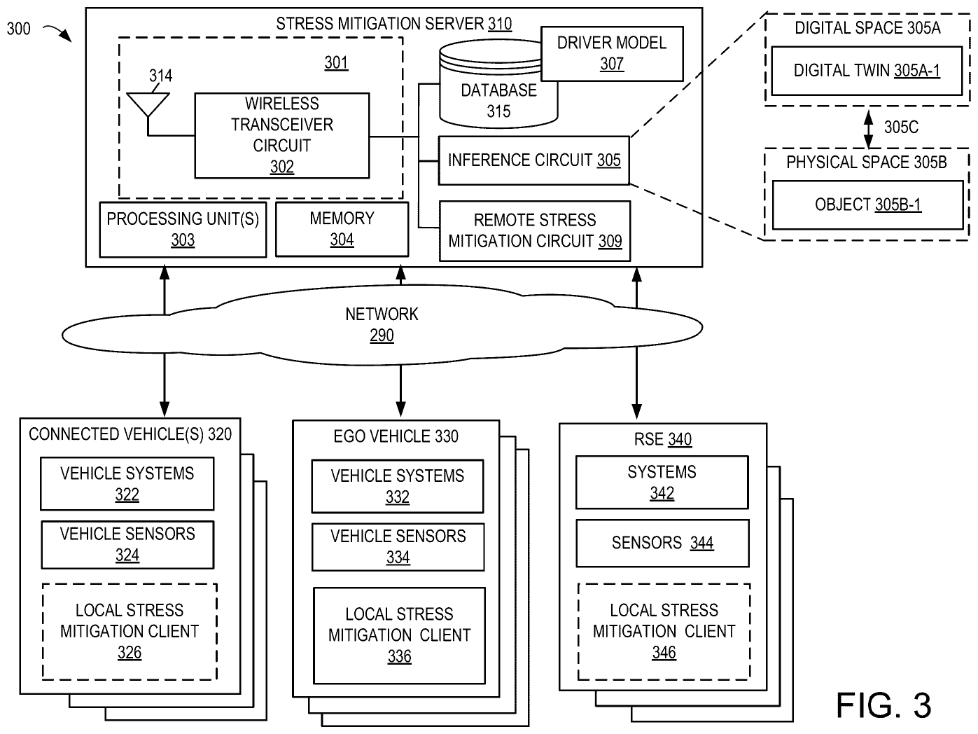

FIG. 3 is an example network architecture 300 of a stress mitigation system in accordance with various embodiments disclosed herein. The architecture 300 includes a stress mitigation server 310 (an embodiment of the aforementioned stress mitigation server), one or more connected vehicles 320 (collectively referred to as connected vehicles or vehicle 320), an ego vehicle 330, and one or more roadside equipment (RSE) 340 (one RSE is shown for illustrative purposes only). Stress mitigation server 310, connected vehicle 320, ego vehicle 330, and RSE 340 can all communicate with one another in this example, directly or through network 290. For example, connected vehicles 320 can communicate with the ego vehicle 330, and the ego vehicle 330 and/or connected vehicles 320 can communicate with the RSE 340, although communication between ego vehicle 330 and, e.g., connected vehicles 320 or RSE 340, is not necessary.

As described previously, stress mitigation server 310 can receive relevant data from an ego vehicle 330, such as its current operating conditions (speed, direction of travel, and so on), along with relevant data regarding, e.g., operating conditions/locations of connected vehicles 320. Stress mitigation server 310 can also receive other relevant data, such as RSE 340-based data, e.g., traffic speed information, traffic density information, etc. Based on this data, and through analysis of the data in conjunction with an ego vehicle driver profile or model, such as a digital twin model, a determination can be made as to whether or not certain ADAS guidance provided to ego vehicle 330 has the potential to induce stress in the driver of ego vehicle 330. If the potential to induce stress exists, stress mitigation server 310 may create an appropriate vehicular cloud comprising one or more vehicles neighboring ego vehicle 330, e.g., one or more of connected vehicles 320. Stress mitigation server 310 may further determine appropriate, e.g., ADAS guidance to be transmitted to each of connected vehicles 320 making up the micro cloud, and can transmit such ADAS guidance (or instructions to generate ADAS guidance) to the respective ADAS of each of the connected vehicles 320 making up the micro cloud. In this way, the connected vehicles 320 making up the micro cloud can be guided in such a way that their operation, e.g., changing speed of travel, changing lanes, etc., can mitigate the potential stress to the driver of ego vehicle 330.

Stress mitigation server 310 may be an edge server, a cloud server, or a combination of the foregoing. For example, stress mitigation server 310 may be an edge server implemented as a processor-based computing device installed in an RSE (e.g., RSE 340 or the like) and/or some other processor-based infrastructure component of a roadway, while a cloud server may be one or more cloud-based instances of processor-based computing device residents on network 290. Server 310 in this example, includes a communication circuit 301, a database 315 which may maintain (temporarily or permanently), a driver model(s) or profile(s) 307, an inference circuit 305, and a remote stress mitigation circuit 309. Inference circuit 305 and remote stress mitigation circuit 309 may comprise code and routines that, when executed by a processor cause the processor to control various aspects of mitigating stress for an ego vehicle driver. Stress mitigation server 310 may include, for example, a microcomputer that includes a one or more processing units (e.g., microprocessors), memory storage (e.g., RAM, ROM, etc.), and I/O devices. Stress mitigation server 310 may store information and data related to stress mitigation (such current operating conditions, the aforementioned driver model(s) 307, and so on) in a cloud-based database 315, which may be resident on network 290. The database 315 may include one or more various forms of memory or data storage (e.g., flash, RAM, etc.) that may be used to store suitable information, such as, one or more of the following elements: position data; vehicle speed data; influence region data; arrangement data; risk mitigation data; target speed data; and stress data, as described below, along with other data as needed The processing units 303 of stress mitigation server 310, execute instructions stored in memory 304 to execute and control functions of the anomalous driving risk mitigation. Processing units 303 and memory 304 may be the same as or similar to or have the same/similar functionality as processor 206/memory 208 of FIG. 2.

Communication circuit 301 includes either or both of a wireless transceiver circuit 302 with an associated antenna 314 and a wired I/O interface with an associated hardwired data port (not illustrated). Communication circuit 201 can provide for V2X communication capabilities, server 310 to communicate with connected devices, such as RSE, edge devices, and/or vehicles via network 290.

As noted above, digital twin technology may be leveraged to infer whether or not ADAS guidance will induce stress in a driver of an ego vehicle, such as ego vehicle 330. Accordingly, inference circuit 305 may be embodied as a digital twin system, the framework of which, may comprise a plurality of functional layers that correspond to: a digital space 305A comprising a digital twin 305A-1 representative of an object of interest 305B-1 (for example, the driver of an ego vehicle, the ego vehicle itself); a physical space 305B associated with objects of interest; and a communications layer 305C that enables communications between the physical and digital spaces 305A/305B. It should be understood that a digital twin can refer to some representation, e.g., virtual, of an object, system, or other entity, again, in this case, a driver of an ego vehicle or the ego vehicle. It should be understood that the digital twin system can include digital twins for both the driver and the ego vehicle. In other embodiments the digital twin system can include digital twins for traffic as well. A digital twin acts as a digital counterpart or model to some physical object or process, such an ego vehicle driver. The physical object/process can be outfitted with or monitored using sensors that generate data regarding various aspects of the physical object/process, e.g., the performance of the physical object. In this case, such sensors may be sensors 252 of an ego vehicle, sensors or data sources, such as an RSE, sensors of or associated with other neighboring vehicles, etc. This generated data can be relayed to a processor or other computing system which may then apply the data to the digital twin. Thereafter, the digital twin or model can be used to run simulations, study performance, generate possible improvements, and so on, in this case, to determine whether an ADAS guidance may induce the driver of the ego vehicle to experience stress. One example of a digital twin system is U.S. application Ser. No. 17/744,452, entitled “Cloud-Based Mobility Digital Twin for Human, Vehicle, and Traffic,” which is incorporated herein by reference in its entirety.

It should be understood that the use of a digital twin system in or as inference circuit 305 is one contemplated implementation. However, other embodiments may leverage machine learning algorithms to create, e.g., a model that can infer or predict the inducement of stress in an ego vehicle driver.

As illustrated in FIG. 3, physical space 305B, in which actors, such as the object of interest 305B-1, logically “reside.” Sampling and actuation processes or procedures may occur in physical space 305B. That is, sensors or devices capable of monitoring actors detect the dynamic status of an actor, any ongoing operations, or any event occurrences associated with the actor or impacting the actor. This sensor data or information, e.g., data samples or measurements, can be aggregated for transmission to digital space 305A. Such data/information can be analyzed or processed by digital space 305A vis-à-vis the respective digital twin to which the data/information apply. Processing/analyzing the data can comprise different operations, but will ultimately produce some output(s) from a mechanism, such as a machine learning algorithm, a resulting perception, etc. that can be used to guide or instruct/command a corresponding actuation to be performed by an actor. That is, the results of the digital twin processing can be used to effectuate actuation operations by the physical entities in physical space 305B. It should be understood that in some embodiments, actuation is not necessarily performed by the actor/object corresponding to the digital twin. For example, in various embodiments, it is the vehicle(s) making up the micro cloud that “actuate,” e.g., perform actions or maneuvers to mitigate stress on the driver of the ego vehicle.

For example, a driver of an ego vehicle may be the object of interest 305B-1 in physical space 305B. In-cabin sensors of the ego vehicle, wellness monitors, e.g., wearable sensors and the like, etc., can be used to sense the state of the driver, such as when the driver experiences stress (sampling). Such information can be communicated to digital twin 305A-1 in digital space 305A, where a machine learning algorithm can be trained with the sampling data to create a driver model that can be used to predict when that driver may experience stress. A vehicle object of interest with its sensors, e.g., sensors 252 can be used to identify driving conditions/scenarios that lead to stress being sensed by the driver. That is, vehicle data/information can be used in conjunction with a driver digital twin, e.g., to train the driver stress algorithm, and generate a driver model. Still other relevant information can come from a traffic actor, where traffic elements, e.g., traffic signals, RSEs, radar, traffic signs, and the like characterizing environmental conditions can also be used in conjunction with the driver digital twin. Simulations can be performed with real-time/current data to determine or predict if current conditions (driving conditions, environmental conditions, etc.) will lead to stress for the driver.

Upon determining that stress-inducing conditions exist or will exist pursuant to ADAS guidance given to the ego vehicle, remote stress mitigation circuit 309 may infer a cause(s) of the stress-inducing conditions, and determine/generate an appropriate vehicular micro cloud to control. That is, remote stress mitigation circuit 309, may learn, from inference circuit 305, that certain conditions that the ego vehicle is in/will be placed in pursuant to the ADAS guidance. Remote stress mitigation circuit 309 may analyze the surrounding environment, vehicles, and traffic conditions about the ego vehicle to determine one or more ways in which the vehicles/traffic can be reorganized to remove the conditions that can lead to stress for the driver of the ego vehicle. Those vehicles that can be reorganized may comprise the micro cloud, e.g., vehicular micro cloud members. It should be understood that in some embodiments, the traffic can be reorganized as well. For example, when safe/appropriate, traffic signal operation at an intersection may be altered, similar to the manner in which vehicles making up the micro cloud can be reorganized. That is, akin to how a vehicle may be guided to alter its operation to, e.g., create space to allow the ego vehicle to comply with the received ADAS guidance without putting the ego vehicle in a position/location where stressful conditions exist for the driver of the ego vehicle, operation of a traffic signal or RSE can be altered or modified to avoid stressful conditions for the driver of the ego vehicle. In other words, elements of a roadway or driving environment, such as RSEs may also make up or be part of the aforementioned micro cloud (or in other scenarios, may be a micro cloud in and of itself/themselves, e.g., one or more RSEs may make up a micro cloud that can be “reorganized” or operationally altered to reduce stress in a similar manner in which vehicular micro cloud members may be reorganized. For example, in the case of RSEs such as traffic lights, timing of light changes, endurance of lighting, etc., may be altered to mitigate stress. For example, if safe to do so, a traffic light RSE may be instructed or controlled to maintain a green light longer than typical/its default setting in order to allow an ego vehicle to pass through an intersection sooner than otherwise might have been feasible to avoid a stressful driving scenario/condition. Accordingly, remote stress mitigation circuit 309 may comprise its own machine learning model(s) or other data analytics mechanisms that can be used to assess the current operation/location/positioning of vehicles and traffic, and subsequently modify such current operation/location/positioning.

As can be appreciated in FIG. 3, communications layer 305C can reside between physical space 305A and digital space 305B. Multiple aspects/elements can make up the communications layer 305C, including an IoT Core, edge gateway, middleware, and bulk data ingestion components (not shown). In some embodiments, the communication circuit 301 may be leveraged for use by/as the communication layer 305C. As described above, the digital twin system's end-to-end process may begin by sampling data in physical space 305A. All or part of the sampled data may then be transmitted upstream to digital space 305B via the communication layer 350C. That sampled data can progress through one or more processes in digital space 305A, internally, including storage, modeling, simulation, learning, prediction, and the like. The resulting output data can be transmitted downstream to physical space 305B via the communication layer 305C. That resulting output data, upon receipt, can be applied by actuators of physical space 305B to fulfill the end-to-end process. It should be noted that while such actuation in the digital twin context is typically performed by the object of interest or actor, in various embodiments, and as explained herein, actuation may be performed by the micro cloud and its vehicular (and/or RSE) micro cloud members. In some embodiments, actuation can be inferred at/by a digital twin, and returned back to the ego vehicle, which may then relay micro cloud reorganization instructions/guidance to the micro cloud members. In other embodiments, stress regarding the operator of an ego vehicle may be inferred by the micro cloud, where micro cloud members may monitor the ego vehicle and infer stress in real-time in the event a driver model for the ego vehicle operator is unknown/not available. For example, default models or generally-known stress inducing situations can be recognized by one or more micro cloud members, and relevant information regarding the situation can be sent to stress mitigation server 310 for analysis, and guidance, or the vehicular micro cloud may itself negotiate amongst its micro cloud members to effect stress mitigation for the ego vehicle through functionality otherwise residing in server 310 being implemented at the respective local stress mitigation clients of the micro cloud members.

Ego vehicles 330 and connected vehicles 320 may each provide similar functionality, and as such ego vehicle may be considered a connected vehicle but for explanation purposes is referred to as the “ego vehicle.” Ego vehicles 330 and connected vehicles 320 may be any type of vehicle, for example, but not limited to, a car; a truck; a sports utility vehicle; a bus; a semi-truck; a drone or any other roadway-based conveyance. Ego vehicles 330 and/or connected vehicles 320 may be implemented as vehicle 100 of FIG. 1. As such, ego vehicle 330 can comprise vehicle systems 332 and vehicle sensors 334 that are substantially similar to vehicle systems 258 and sensors 252 of FIG. 2. Ego vehicle 330 also includes local stress mitigation circuit 336, which may be substantially similar to local stress mitigation circuit 210 of FIG. 2. Similarly, connected vehicle 320 comprises vehicle systems 322 and vehicle sensors 324 that are substantially similar to vehicle systems 258 and sensors 252 of FIG. 2, along with local stress mitigation circuit 326 that is substantially similar to local stress mitigation circuit 210 of FIG. 2.

Ego vehicle 330 (and/or connected vehicle 320) may have V2X communication capabilities, allowing vehicles to communicate with edge devices, roadside infrastructure (e.g., such as RSE 340, which may be a vehicle-to-infrastructure (V2I)-enabled street light and/or cameras, for example). Vehicle 330 (or vehicles 320) may also communicate with other vehicles 320 over vehicle-to-vehicle (V2V) communications. It should be understood that sometimes, a vehicle itself may act as a network node, edge computing device, or a combination thereof. For example, vehicle 330 may operate as a network edge device. The data gathered by vehicles 330 (or vehicles 320), either through their own sensors, and/or other data sources, e.g., RSE 340 and other vehicles, may be ultimately be transmitted to stress mitigation server 310. Furthermore, in some embodiments, a vehicle itself may act as a edge server.

The RSE 340 includes a local stress mitigation circuit 346, systems 342, and sensors 344. The RSE 340 can be implemented, for example, as a computing component, such as computing component 900 of FIG. 9. The sensors 344 may be similar to sensors 252, for example, comprising environmental sensors 228 (e.g., to detect salinity and/or other environmental conditions), proximity sensor 230 (e.g., sonar, radar, lidar and/or other vehicle proximity sensors), and image sensors 260 the like for capturing data of an environment surrounding the RSE 340. Systems 342 may include, for example, object detection system 278 to perform image processing such as object recognition and detection on images from image sensors 260, proximity estimation, for example, from image sensors 260 and/or proximity sensors, etc. The local stress mitigation circuit 346 includes code and routines that are operable, when executed, to cause the RSE 340 to perform similar functionality as described above in connection with local stress mitigation client 205 based on sensor data collected by sensors 344 and/or systems 342. The local stress mitigation circuit 346 may be operated to detect conditions/elements and transmit sensor data to stress mitigation server 310 or receive guidance to alter its operation. It should be understood that such guidance provided to RSE 340 is not ADAS guidance, but as described above, nevertheless guidance to alter operation to mitigate stress on the ego vehicle driver. The RSE 340 may also have known geographic coordinates and/or comprises a GPS unit of its own.

In various embodiments, stress mitigation server 310 receives stress data packaged in a notification message, which notifies stress mitigation server 310 of an occurrence of receipt of ADAS guidance by ego vehicle 330. As described above, the stress data may also include digital data characterizing or otherwise regarding driving conditions or behavior, environmental conditions, and so on, as described above.

Stress mitigation server 310, vis-à-vis remote stress mitigation circuit 309 identifies nearby connected vehicles within a geographic area of ego vehicle 330 (indicated in the stress data), such vehicles making up a micro cloud. For example, from the stress data, stress mitigation server 310 can determine/compute a geographic region surrounding ego vehicle 330, connected vehicles within which can be reorganized (repositioned/guided to alter speed of travel/etc.) to negate any conditions that stress mitigation server 310, vis-à-vis inference circuit 305, determines may lead to stress for the driver of ego vehicle 330. For example, the geographic area may be defined as a predetermined distance in front of, behind and to the sides of ego vehicle 330, or it may be defined as a predetermined radius around ego vehicle 330. Other manners of determining a relevant geographic area/micro cloud may be leveraged. An example implementation of determining geographic areas can be found in U.S. Pat. No. 11,380,198, the disclosure of which is incorporated herein by reference in its entirety.

From the geographic region, stress mitigation server 310 may identify all vehicles therein (the micro cloud) that may be reorganized to achieve stress mitigation for the driver of ego vehicle 300. For example, stress mitigation server 310 identifies connected vehicles 320 being at least partially within the relevant geographical area. For example, connected vehicle 320 and ego vehicle 330 may transmit current (e.g., most recent) vehicle position data (such as GPS data and/or other vehicle position data) to stress mitigation server 310, which stress mitigation server 310 can use to confirm whether each vehicle is within the geographic region.

In some embodiments, stress mitigation server 310, again by way of remote stress mitigation circuit 309, can also generate predictive movement pattern data. For example, in some embodiments, recent movement patterns of ego vehicle 330 and connected vehicles 320 (comprising the micro cloud) may be applied to machine learning models trained in time-series analysis to predict future movement patterns of such vehicles. For example, connected vehicles 320 within the vicinity of ego vehicle 330 upon ego vehicle 330 receiving ADAS guidance may each transmit position/location/operational data to stress mitigation server 310, which accumulates the data into an aggregate time-series stress data. The stress mitigation server 310 can then apply trained machine learning models on the aggregate time-series stress data to infer future movement patterns, and based on this, generate appropriate ADAS guidance (or other guidance) that can be transmitted to connected vehicles 320, and that when followed, reduces/eliminates the stress the driver of ego vehicle 330 would have otherwise experienced. The predicted movement pattern data may be derived from inferences made using recent movement patterns unique to the anomalous driving behavior, historical movement patterns unique to the anomalous driving behavior, or a combination thereof. For example, once the path of the ego vehicle 330 is determined (pursuant to complying with ADAS guidance received by ego vehicle 330), stress mitigation server 310 generates an arrangement of vehicles, i.e., reorganizes the micro cloud, around/about ego vehicle 330. For example, from current (e.g., most recent) position data for each connected vehicle 320, the server 310 determines a mitigated stress position for each connected vehicle 320 relative to the path and relative to the other connected vehicles 320. For example, the mitigated stress positions can be determined so as to form gaps between adjacent or neighboring connected vehicles 320 through which the path (of ego vehicle 330) may traverse. Stress mitigation server 310 uses the current connected vehicles 320 speeds and the current positions of connected vehicles 320, to determine speeds and maneuvers that would result in each connected vehicle 320 being guided to its respective position relative to the other connected vehicles 320, thereby resulting in the determined arrangement or reorganization of the micro cloud.

Stress mitigation server 310 then packages the stress data into a command message, which is transmitted to each connected vehicle 320 of the micro cloud via communication circuit 301 over network 290. As described above, the stress mitigation circuit 326 of each connected vehicle 320 receives its corresponding command message and transmits the command message to systems 322, which as noted above, can be an ADAS, e.g., autonomous/semi-autonomous system.

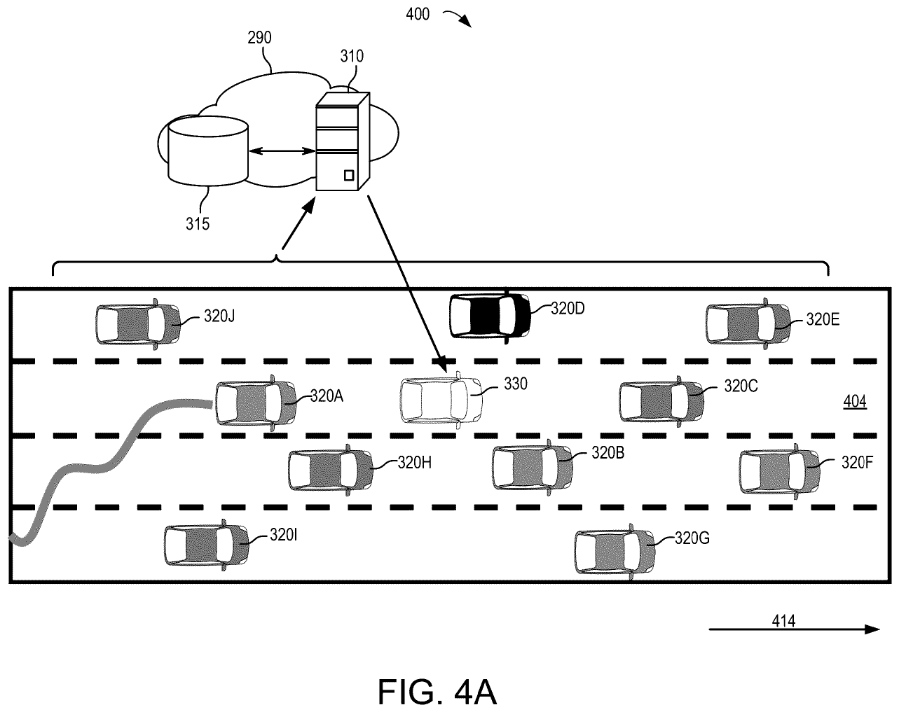

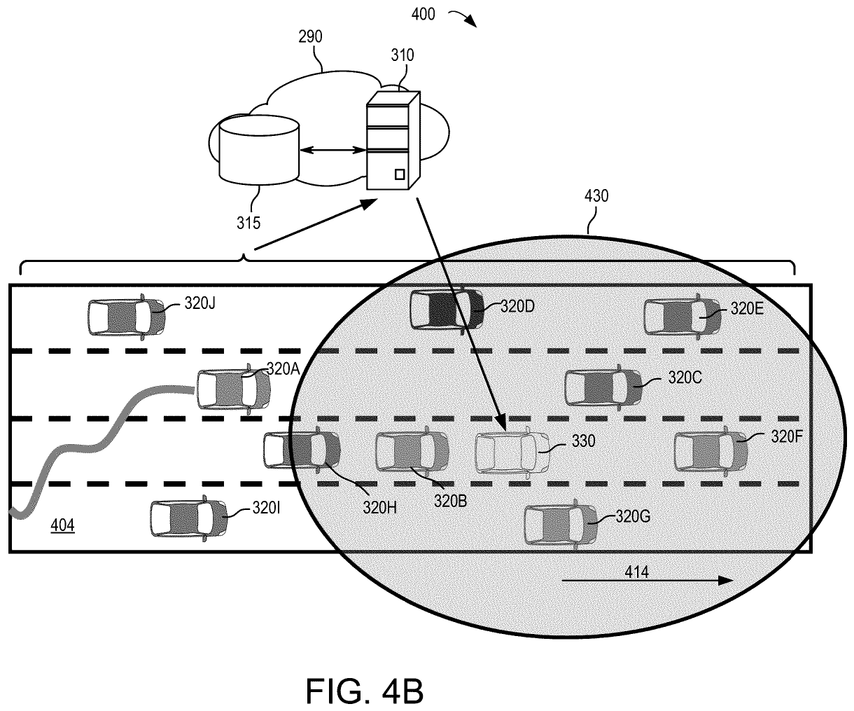

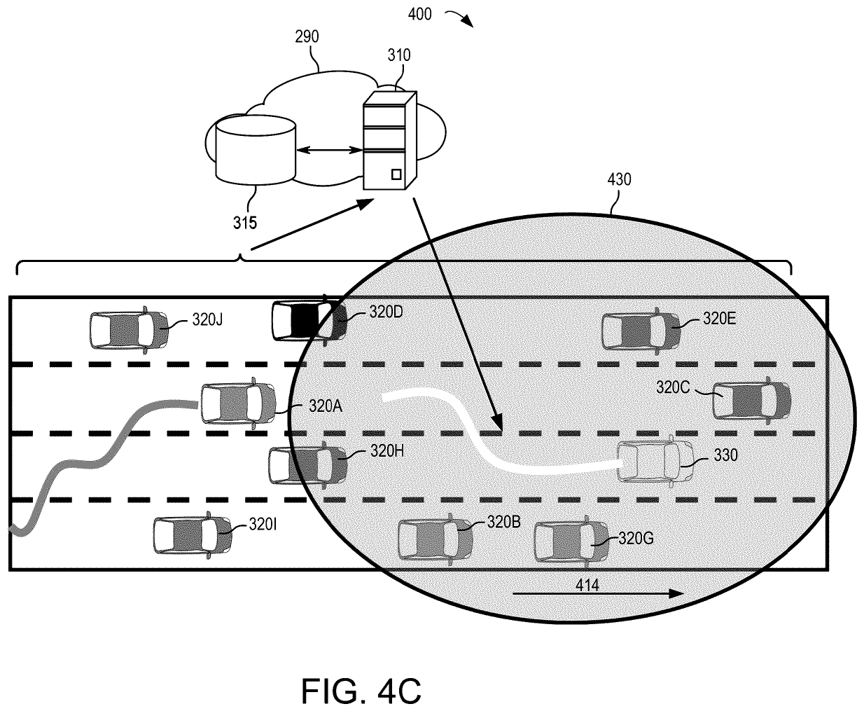

FIGS. 4A-4C illustrate an example stress mitigation scenario in accordance with one embodiment of the present application. FIG. 4A illustrates an example roadway environment 400, in which ego vehicle 330 and connected vehicles 320A-320J (collectively referred to herein as connected vehicles 320) are traveling along a section of roadway 404 in a traveling direction 414. Roadway environment 400 also includes stress mitigation server 310 and cloud-based database 315 as described above, with which the ego vehicle 330 and connected vehicle 320 are connected to via, e.g., V2X communication over network 290. Roadway environment 400 includes vehicle 320A which is exhibiting anomalous driving behavior, prompting ADAS guidance to be provided to ego vehicle 330 to avoid vehicle 320A. That is, vehicle 320A may be exhibiting undesirable driving behavior, in this example, high-speed weaving in/around surrounding traffic).

FIG. 4B illustrates that ADAS guidance instructs ego vehicle 300 to change lanes to avoid the undesirable driving behavior of vehicle 320A. However, that ADAS guidance relocates vehicle 320A to a position that causes the driver of ego vehicle 330 stress, in this example, vehicles 320B-320G surround ego vehicle 330 closely-too close for the comfort of ego vehicle 330's driver. After assessing that the ADAS guidance provided to ego vehicle 330 could/will cause stress, stress mitigation server 310 (as described above) determines a micro cloud 430 that can be reorganized to mitigate the stress that the driver of ego vehicle 330 would feel without the benefit of the disclosed technology. In this example, stress mitigation server 310 determines that the micro cloud 430 should include connected vehicles 320B-320G. It should be noted that stress mitigation server 310 may not necessarily provide micro cloud reorganization guidance or instructions to each connected vehicle in a geographical area comporting with the micro cloud. For example, in some instances, the geographical area deemed to be relevant to mitigating stress for an ego vehicle driver may include certain vehicles that may be able to remain as they are. In other scenarios, one or more vehicles in the geographical area may not be a connected vehicle, in which case, guidance/instructions cannot be provided to those vehicles via stress mitigation server 310. Accordingly, stress mitigation server 310 may treat such vehicles as obstacles or infrastructure to reorganize around.

FIG. 4C illustrates the reorganization of the vehicular micro cloud in accordance with one embodiment. In this example, stress mitigation server 310 may provide guidance instructing the following: connected vehicle 320G remains in its current lane and maintains its current speed (such can be provided as guidance, i.e., to maintain its current course) or in some embodiments, because connected vehicle 320G stays its current course, guidance is not necessary; connected vehicle 320B is instructed to change from its current lane of travel to the next lane to its right; connected vehicles 320C and 320F (no longer seen) are instructed to speed up and drive in the direction of 414. In this way, ego vehicle 330 can avoid vehicle 320A, while avoiding the stress of being “pinned” between certain neighboring vehicles (as illustrated in FIG. 4A). By reorganizing the micro cloud 430, ego vehicle 330 can proceed in the lane to which it was instructed to change without creating stress for the driver of ego vehicle 330.

It should be noted that embodiments of the disclosed technology contemplate various ways in which a micro cloud may be generated. In some embodiments, depending on the scenario, the micro cloud may be a stationary micro cloud. Stationary micro clouds may be relevant or appropriate in scenarios involving an intersection, where connected vehicles may be instructed to remain stationary to avoid causing stress to an ego vehicle driver. The ego vehicle driver may experience stress when traversing an intersection simultaneously with one or more other vehicles. In other embodiments, a particular connected vehicle may be deemed to be or elected to be a micro cloud leader. In such embodiments, the micro cloud leader may take on the functionality or at least part of the functionality of stress mitigation server 310. Such an arrangement may be advantageous in a mobile context, where, for example, the relevant geographical area in which an ego vehicle driver may experience stress is ongoing. The use of a (in this scenario, vehicular) micro cloud leader, can be advantageous in that the micro cloud leader can move with the ego vehicle making the need to, e.g., “handover” to different stress mitigation servers. Additionally, the vehicular micro cloud leader can also obtain/provide substantially constant/up-to-date stress data, avoiding a need to communicate with potentially different RSE or connected vehicles that may be relevant in one period during the travel of the ego vehicle, and not relevant in a subsequent period, and so on. Still other types of micro clouds contemplated by various embodiments includes chained, interdependent micro clouds that can work together to effectuate stress mitigation. For example, a first micro cloud may reorganize and provide stress data to a second/next vehicular micro cloud, and so on, the result being a chain of micro clouds that “follows” the travel of the ego vehicle. In still other embodiments, vehicles or other members of a first micro cloud may “spin out” and become part of another micro cloud. For example, following the example of the chained, interdependent vehicular micro cloud, certain connected vehicles may be traveling such that they enter another/next micro cloud and should be taken into consideration when attempting to mitigate stress of the ego vehicle driver. In still other embodiments, micro clouds may be generated “remotely” meaning well in advance of an ego vehicle, e.g., where the ego vehicle is not within the geographical area according to which the micro cloud is generated. For example, a determination may be made, e.g., by a stress mitigation server that ADAS guidance includes traversing a path that will eventually lead the ego vehicle to some “required” or necessary maneuver, e.g., a left lane change at high speed. In such a scenario, the micro cloud at that the eventual location/area where the required maneuver is to occur, the vehicular micro cloud members may be intelligently arranged to accommodate the maneuver without causing stress by the time the ego vehicle reaches the location/area.

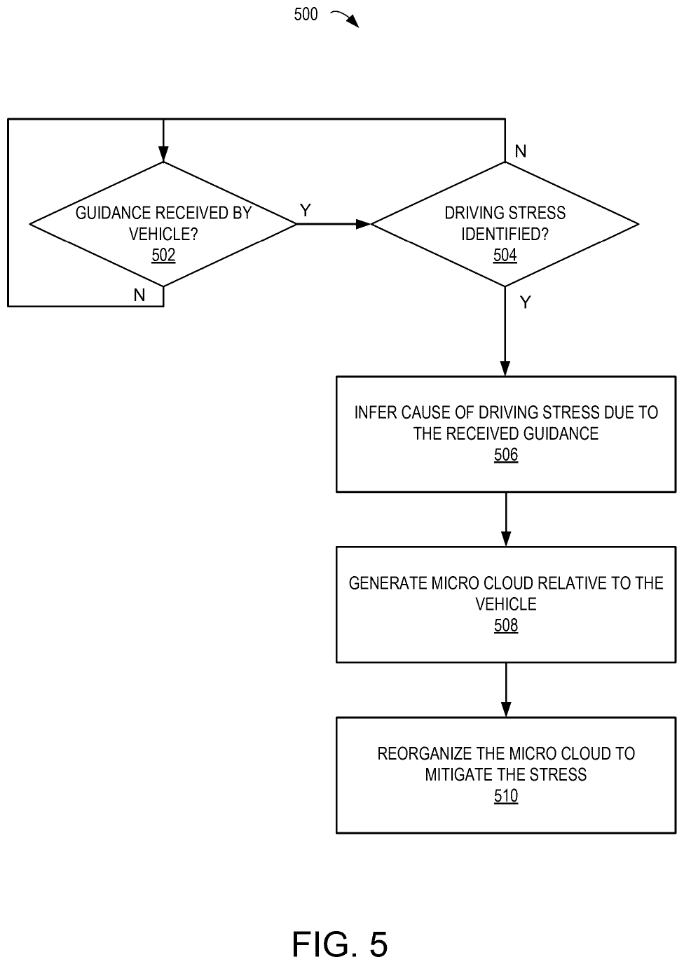

FIG. 5 is a flow chart illustrating example operations for mitigating stress in accordance with various embodiments disclosed herein. FIG. 5 illustrates a process 500 that may be implemented as instructions, for example, stored on stress mitigation server 310, that when executed by one or more processors perform the operations of process 500. The process 500 will be described hereinafter in the context of the roadway environment 400 of FIGS. 4A-4C.

At 502, a check can be performed to determine if guidance has been received by a vehicle. As described above, an ego vehicle may receive ADAS guidance, and that ADAS guidance can be relayed to a stress mitigation server. In other embodiments, such guidance may be remotely-generated guidance from a remote operator. In still other embodiments, such guidance may be any control guidance/instructions to be effectuated by a vehicle. Receipt of information indicating that an ego vehicle has received ADAS guidance can prompt the stress mitigation server to initiate a process of determining whether or not the ADAS guidance can or will induce stress in the driver of the ego vehicle. If no ADAS guidance was received, the stress mitigation server need not act. It should be understood that receipt of information indicating that an ego vehicle has received ADAS guidance alone can prompt the stress determination without the stress mitigation server having to perform a separate check.

In the event ADAS guidance was received by the ego vehicle (at 502), subsequently at 504, the stress mitigation server can determine, as alluded to above, whether or not the ADAS guidance can/may cause stress to the driver of the ego vehicle. The use of a digital twin system or machine learning technologies may be leveraged to determine whether or not the driver of the ego vehicle may experience stress due to the ADAS guidance to be followed. Along with information regarding the ADAS guidance, the stress mitigation server may receive relevant information/data from sensors of the ego vehicle, sensors of neighboring vehicles, information from other information sources, RSE, and the like. Such stress data can be used in conjunction with a driver model to determine if current driving/environmental/driver behavior reflected by or in the stress data corresponds to the inducement of stress according to the driver model. For example, the model may be a digital twin model representative of the driver of the ego vehicle that has been trained using sampled data from the physical space in which the driver of the ego vehicle resides. If the same/similar conditions exist in a current driving scenario/environment, stress to the driver of the ego vehicle can be inferred.

If, at 504, the existence or potential for stress was identified, at 506, the cause of the driving stress due to the received guidance (e.g., the receipt of the guidance itself, compliance with or performance of the received guidance, etc.) can be inferred. That is, guidance may involve various actions/maneuvers, e.g., an instruction to change lanes may involve speeding up or slowing down, turning a certain direction, by a certain amount, etc., and as explained above, the surrounding environment may involve/include a variety of elements/conditions one or more of which may actually be the cause of the identified stress to the driver/passenger of the ego vehicle. Following an earlier example, an ego vehicle driver, per his/her driver model, may experience stress when he/she is positioned alongside a semi-truck. However, the guidance received would is merely to change lanes. Accordingly, stress mitigation server 500 infers what about the environment/conditions actually may cause or contribute to the identified stress.

At 508, the stress mitigation server can generate a micro cloud relative to the vehicle. As noted above, the micro cloud may be a micro cloud comprising one or more vehicles (vehicular micro cloud members) neighboring or to-be-neighboring an ego vehicle that may contribute to the identified stress or can be controlled to mitigate the identified stress. As also noted above, the micro cloud need not be limited in kind, e.g., RSEs may be a part of the micro cloud, the micro cloud may comprise only vehicles, only RSEs (or other environmental elements), or some combination thereof. It should be noted that the term “micro” is not used to suggest any particular size/geographical limitation, but rather to suggest some area or element/group of elements, such as vehicles, that may impact an ego vehicle driver's/passenger's driving experience in terms of stress. As discussed above, a vehicular micro cloud can be generated based on some geographical area about the ego vehicle (or in some cases outside/away from the ego vehicle depending on the circumstances, e.g., when the stress mitigation server determines a need to generate a remote micro cloud (relative to the ego vehicle)). The geographical area may represent some region in which the driver of the ego vehicle will experience stress, while the micro cloud comprises one or more other vehicles within that geographical area or outside (as alluded to above), but nevertheless relevant to mitigating stress on the driver of the ego vehicle. In other words, the micro cloud comprises those vehicles that can/should be reorganized to mitigate such stress.

Accordingly, at 510, upon determining which vehicles should be reorganized, the stress mitigation server will instruct those vehicles to reorganize accordingly. For example, the stress mitigation server may send or instruct the respective ADAS (or ADS or other motive control system(s)/actuator(s)) of the vehicles to provide guidance commensurate with the desired reorganization. In this way, the operation of the vehicles can be altered or adjusted, e.g., to change speed, change lanes, etc. so that the stress that would have been caused by adhering to the ADAS guidance received by the ego vehicle will be negated or mitigated.

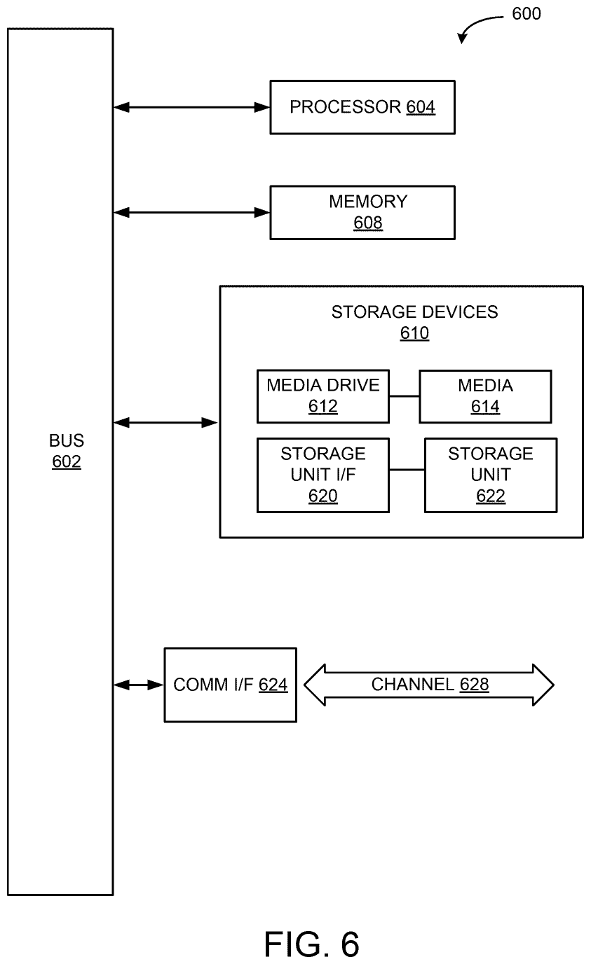

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up stress mitigation system 200 of FIG. 2 and/or server 310 of FIG. 3. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
identifying, at a stress mitigation server, existence of stress to a passenger of a vehicle upon receipt of vehicle guidance by the vehicle;
inferring, by the stress mitigation server, a cause of the stress due to the received guidance;
generating, by the stress mitigation server, a micro cloud relative to the vehicle; and
reorganizing, by the stress mitigation server, the micro cloud to mitigate the stress.

2. The method of claim 1, wherein the vehicle guidance comprises advanced driving assistance system (ADAS) or autonomous driving system (ADS) guidance.

3. The method of claim 1, wherein identifying the existence of stress comprises receiving driving conditions characterizing a current driving environment at a digital twin system.

4. The method of claim 3, further comprising performing one or more simulations using a digital twin representative of the passenger at the digital twin system based on the received driving conditions.

5. The method of claim 3, wherein the receipt of the vehicle guidance occurs at a local stress mitigation circuit of the vehicle.

6. The method of claim 5, wherein the local stress mitigation circuit of the vehicle is operatively connected to the stress mitigation server, the stress mitigation server comprising a remote stress mitigation circuit corresponding to the local stress mitigation circuit of the vehicle.

7. The method of claim 1, wherein the inferring of the cause of the stress comprises identifying one or more aspects or results of the received guidance leading to the existence of the stress.

8. The method of claim 1, wherein generating the micro cloud comprises identifying at least one or more elements of an environment relative to the vehicle or one or more geographical areas relative to the vehicle that is the cause of the stress or can be reorganized to mitigate the stress.

9. The method of claim 8, wherein the micro cloud comprises at least one of one or more vehicles neighboring the vehicle, one or more vehicles to-be-neighboring the vehicle, or one or more roadside equipment.

10. The method of claim 9, wherein the reorganization of the micro cloud comprises altering at least one of a current operating speed or current direction of travel of the one or more vehicles neighboring the vehicle, or one or more vehicles to-be-neighboring the vehicle.

11. The method of claim 10, wherein the altering of the at least one the current operating speed or current direction of travel of the one or more vehicles neighboring the vehicle, or one or more vehicles to-be-neighboring the vehicle, comprises transmitting, by the stress mitigation server, guidance, to a respective local stress mitigation circuit of the one or more vehicles neighboring the vehicle, or the one or more vehicles to-be-neighboring the vehicle.

12. The method of claim 10, wherein the reorganization of the micro cloud comprises altering a current operating condition of the one or more roadside equipment.

13. The method of claim 12, wherein the altering of the current operating condition of the roadside equipment, comprises transmitting, by the stress mitigation server, guidance, to a respective local stress mitigation circuit of the one or more roadside equipment.

14. A system, comprising:
one or more local stress mitigation circuits; and
a stress mitigation server operating to:
receive driving conditions characterizing a current driving environment relative to an ego vehicle upon the ego vehicle receiving driving guidance;
identify existence of stress to a passenger of the vehicle based on known passenger characteristics and learned impact of the received driving conditions relative to the known passenger characteristics;
infer a cause of the stress due to the received driving guidance;
generate a micro cloud relative to the ego vehicle; and
transmit, to the one or more local stress mitigation circuits, instructions reorganizing the micro cloud to mitigate the stress.

15. The system of claim 14, wherein the one or more local stress mitigation circuits is implemented in at least one of one or more vehicles neighboring the vehicle, one or more vehicles to-be-neighboring the vehicle, or one or more roadside equipment.

16. The system of claim 15, wherein the at least one of the one or more vehicles neighboring the vehicle, the one or more vehicles to-be-neighboring the vehicle, or the one or more roadside equipment are members of the micro cloud.

17. The system of claim 16, wherein the stress mitigation server generates the micro cloud by identifying at least one or more elements of the current driving environment or a future driving environment relative to the vehicle, or one or more geographical areas relative to the vehicle that is the cause of the stress or can be reorganized to mitigate the stress.

18. The system of claim 16, wherein the instructions reorganizing the micro cloud comprises instructions to alter at least one of a current operating speed or current direction of travel of the one or more vehicles neighboring the vehicle, or one or more vehicles to-be-neighboring the vehicle.

19. The system of claim 16, wherein the instructions reorganizing the micro cloud comprises instructions to alter a current operating condition of the one or more roadside equipment.

20. The system of claim 14, wherein the stress mitigation server identifies the existence of stress by performing one or more simulations using a digital twin representative of the passenger of the vehicle at a digital twin system implemented as part of the stress mitigation server based on the received driving conditions.
